(19) United States
(12) Patent Application Publication
(10) Pub. No.: US 2025/0225232 A1
(43) Pub. Date: Jul. 10, 2025

(54) PROTECTED FINE-TUNING OF A MACHINE LEARNING MODEL

(71) Applicant: MICROSOFT TECHNOLOGY LICENSING, LLC, Redmond, WA (US)

(72) Inventors: Wei FANG, CN (CN); Bei LU, CN (CN); Xia XIAO, CN (CN); Qian WANG, CN (CN); Fan MA, CN (CN); Yu XIA, CN (CN); Feng PAN, Redmond, WA (US); Peng YU, Sammamish, WA (US); Yunjie ZHANG, Redmond, WA (US); Pradeep Kumar GUNDA, Redmond, WA (US); Andrew Nelson SCHONHOFFER, Boston, MA (US); Meiqiu WANG, Redmond, WA (US); Colin Julian MACGINNITIE, Newton, MA (US); Aditya YADAV, Medford, MA (US); Ali Can SOYLEMEZOGLU, Cambridge, MA (US); Feng LI, Sammamish, WA (US); Jithendra Kumar VEERAMACHANENI, Sammamish, WA (US); Karthik RAMAN, Sammamish, WA (US)

(21) Appl. No.: 18/724,145

(22) PCT Filed: Dec. 30, 2021
(86) PCT No.: PCT/CN2021/142842

§ 371 Date: Jun. 25, 2024

(51) Int. Cl. G06F 21/53; G06N 20/00

(52) U.S. Cl. CPC G06F 21/53; G06N 20/00

(57) ABSTRACT

The fine-tuning of a machine learning model in a protected environment. Input (e.g., training data) received from the tune initiator system that instructs the tuning occur is received over a channel that is visible to the tune initiator system. Proprietary input is received from another party over a secure connection that is not visible to the tune initiator system. These inputs are then used to fine-tune a machine learning model to thereby form a fine-tuned machine learning model. The resulting fine-tuned machine learning model is then stored in the protected environment such that the fine-tuned machine learning model is available for the tune initiator system to provide input data to and receive output data from, but such that the tuned model cannot be directly accessed by the tune initiator system.

### CROSS REFERENCE PARAGRAPH

The present application is a U.S. National Stage of International Application No. PCT/CN21/142842, filed on 30 Dec. 2021. The aforementioned application is incorporated herein in its entirety by this reference.

### BACKGROUND

Machine learning is an area of technology that allows for the automated building of analytical models. Supervised machine learning is a subcategory of machine learning.

In supervised machine learning, labelled datasets are used to train a model to be able to classify the data or accurately predict outcomes based on the data. The labels are the actual correct answer given the associated input data. For instance, suppose that the input data was a picture of a cat, and the model was being trained to classify pictures of animals by the animal depicted. The label would actually specify “cat”.

The labels of the dataset are used to determine if the model made a proper classification or prediction. Based on whether or not the model made a classification or prediction that matches the correct answer specified in the label, the training algorithm adjusts the model. Adjustment continues again and again for new training data until the model is fit for making accurate classifications or predictions. There are a variety of training algorithms for properly training a model. Later, at inference time, unlabeled data is fed to the model with the aim of providing a classification or prediction based on that new data.

Once a model is trained, the model can be repurposed to perform new tasks. Thus, training can begin with a previously trained model-allowing the training to continue further to fine-tune the model for the new task. This reduces the time and training data required to train a model for performing a new task. “Fine-tuning” a base model is a process of formulating a fine-tuned model based on a base model. Fine-tuning involves acquiring a base model that had already been trained, applying the base model to new training data, and making further adjustments to the model based on the new training data.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Fine-tuning a previously trained model to perform a new task is much more efficient than training a new model from the beginning. This is because if the new task is quite comparable to what the model was originally trained for, the model will already have parameter values that are mostly in place already. The parameter values just need to be fine-tuned to perform the new task. Here, the model as it exists prior to fine-tuning will be referred to as a “base model”. The model as it exists after fine-tuning will be referred to as a “tuned model”. A computing system that initiates (i.e., requests) the fine-tuning will be referred to as a “tune initiator computing system” or “tune initiator system”.

To be able to form a tuned model by fine-tuning a base model, the tune initiator system should typically have access to the base model and a tuning algorithm. The tune initiator system would then provide new training data (adapted to the new task) to the base model to thereby cause the base model to be tuned in accordance with the tuning algorithm.

However, the user(s) of the tune initiator system might not be the owner of the base model, and the base model provider may be hesitant to share their base model. For instance, the base model provider may consider various aspects of the base model to be proprietary. Alternatively, or in addition, the tune initiator system may not have possession of the tuning algorithm. The principles described herein allow a tune initiator system to formulate and use a tuned model while providing security to any entity that provides the base model and/or the tuning algorithm. In other words, entities can allow the tune initiator system to use their proprietary information (such as the base model and/or tuning algorithm) to formulate a tuned model, without disclosing their proprietary information to the tune initiator system.

In accordance with the principles described herein, the fine-tuning of a machine learning model in a protected environment is described. The fine-tuning includes receiving some input (“first input”) into the protected environment from the tune initiator system via a first channel that is visible to the tune initiator system. Such information would include at least training data to be used in the fine-tuning process. The fine-tuning also includes accessing other input (“second input”) over a second channel that is not visible to the tune initiator system. Such second input would include the proprietary information of a party that is allowing the tune initiator system to use (but not see) that proprietary information in performing the fine-tuning.

The first and second inputs are then used to fine-tune a machine learning model to thereby form a fine-tuned machine learning model. The resulting fine-tuned machine learning model is then stored in the protected environment such that the fine-tuned machine learning model is available for the tune initiator system to provide input data to and receive output data from, but such that the fine-tuned machine learning model cannot be directly accessed by the tune initiator system.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates a network environment in which the principles described herein may be employed, which includes a tune initiator system and a provider system that each provide some input to a mode fine-tuning processing, and which further includes a protected system in which the fine-tuning actually occurs;

FIG. 2 illustrates a flowchart of a method for fine-tuning a machine learning model in a protected environment, in accordance with the principles described herein;

FIG. 3A illustrates an example of the first input that is received from the tune initiator system;

FIG. 3B illustrates an example of the second input that is received from the provider system;

FIG. 4 illustrates a flowchart of a method for the tune initiator system (or any other authorized system) to use the fine-tuned model to access an inference generated by that fine-tuned model;

FIG. 5 illustrates an environment that represents an example of the environment of FIG. 1;

FIG. 6 illustrates an example lock-down compute, which represents an example of the lock-down compute of FIG. 5; and

FIG. 7 illustrates an example computing system in which the principles described herein may be employed.

### DETAILED DESCRIPTION

Fine-tuning a previously trained model to perform a new task is much more efficient than training a new model from the beginning. This is because if the new task is quite comparable to what the model was originally trained for, the model will already have parameter values that are mostly in place already. The parameter values just need to be fine-tuned to perform the new task. Here, the model as it exists prior to fine-tuning will be referred to as a “base model”. The model as it exists after fine-tuning will be referred to as a “tuned model”. A computing system that initiates (i.e., requests) the fine-tuning will be referred to as a “tune initiator computing system” or “tune initiator system”.

To be able to form a tuned model by fine-tuning a base model, the tune initiator system should typically have access to the base model and a tuning algorithm. The tune initiator system would then provide new training data (adapted to the new task) to the base model to thereby cause the base model to be tuned in accordance with the tuning algorithm.

However, the user(s) of the tune initiator system might not be the owner of the base model, and the base model provider may be hesitant to share their base model. For instance, the base model provider may consider various aspects of the base model to be proprietary. Alternatively, or in addition, the tune initiator system may not have possession of the tuning algorithm. The principles described herein allow a tune initiator system to formulate and use a tuned model while providing security to any entity that provides the base model and/or the tuning algorithm. In other words, entities can allow the tune initiator system to use their proprietary information (such as the base model and/or tuning algorithm) to formulate a tuned model, without disclosing their proprietary information to the tune initiator system.

In accordance with the principles described herein, the fine-tuning of a machine learning model in a protected environment is described. The fine-tuning includes receiving some input (“first input”) into the protected environment from the tune initiator system via a first channel that is visible to the tune initiator system. Such information would include at least training data to be used in the fine-tuning process. The fine-tuning also includes accessing other input (“second input”) over a second channel that is not visible to the tune initiator system. Such second input would include the proprietary information of a party that is allowing the tune initiator system to use (but not see) that proprietary information in performing the fine-tuning.

The first and second inputs are then used to fine-tune a machine learning model to thereby form a fine-tuned machine learning model. The resulting fine-tuned machine learning model is then stored in the protected environment such that the fine-tuned machine learning model is available for the tune initiator system to provide input data to and receive output data from, but such that the fine-tuned machine learning model cannot be directly accessed by the tune initiator system.

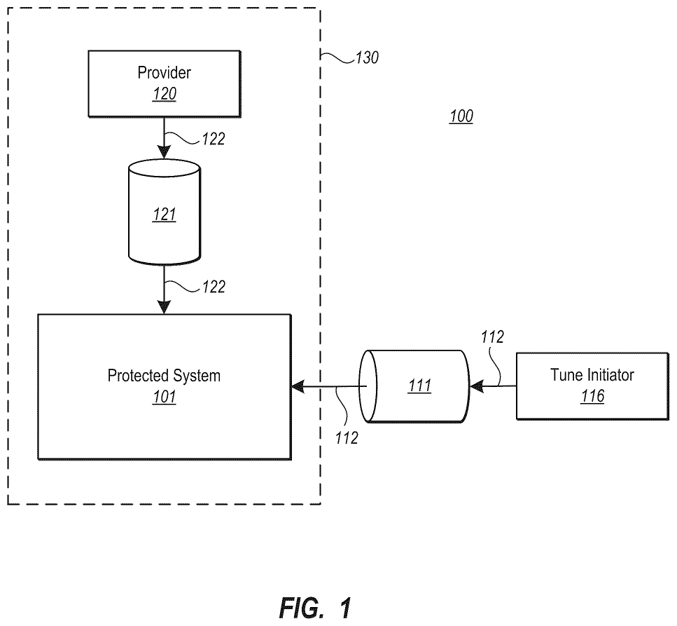

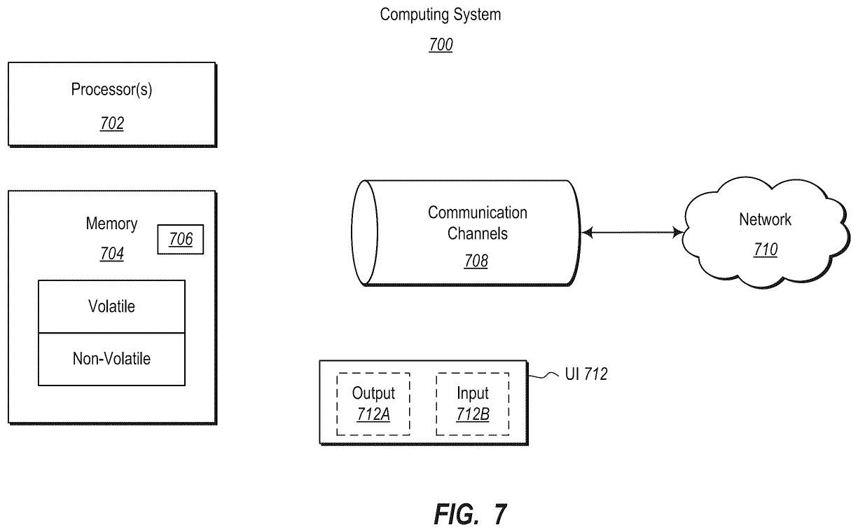

FIG. 1 illustrates a network environment 100 in which the principles described herein may be employed. The network environment 100 includes a protected system 101, a tune initiator computing system 110 and a provider computing system 120, each of which may be structured as described below for the computing system 700 of FIG. 7. The protected system may also be referred to herein as a “protected environment”.

The protected system 101 is a computing system in which the fine-tuning actually occurs. The tune initiator system 110 initiates the fine-tuning process and provides (as represented by arrow 112) training data and potentially other data (“first data”) to facilitate the fine-tuning process. This first input is provided over a first channel 111 that is visible to the tune initiator computing system 110. The provider computing system 120 provides (as represented by arrow 122) proprietary input (“second input”) that facilitates the fine-tuning processes. This second input is provided over a second channel that is not visible to the tune initial computing system 110. The dash-lined boundary 130 symbolically represents that the tune initiator computing system 110 does not have a view into the environment in which fine-tuning occurs.

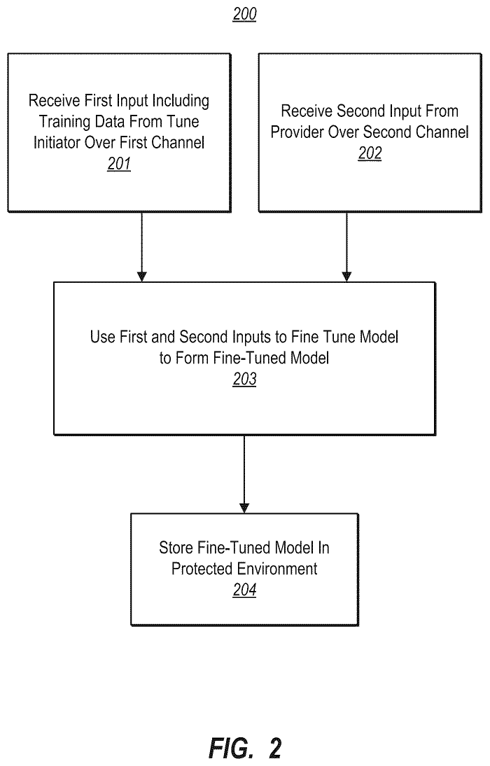

FIG. 2 illustrates a flowchart of a method 200 for fine-tuning a machine learning model in a protected environment, in accordance with the principles described herein. The fine-tuning occurs such that the tune initiator system that instructs that the fine-tuning occur does not have visibility on proprietary input provided by another party, and does not have visibility on a resulting fine-tuned model. As the method 200 may be performed by the protected system 101 of FIG. 1, the method 200 of FIG. 2 will now be described with frequent reference to the environment 100 of FIG. 1.

The method 200 includes receiving first input that includes training data into the protected environment from the tune initiator system via a first channel that is visible to tune initiator system, the first input including training data (act 201). Referring to FIG. 1, the protected system 101 receives (as represented by arrow 112) first input from the tune initiator system 110 over the first channel 111 that is visible to the tune initiator system 110. In this description and in the claims, a channel is “visible” to the tune initiator system if the tune initiator system can see data transferred over the channel.

The method 200 also includes accessing second input over a second channel that is not visible to the tune initiator system (act 202). Referring to FIG. 1, the protected system 101 receives (as represented by arrow 122) second input from the provider system 110 over the second channel 121 that is not visible to the tune initiator system 110. In this description and in the claims, a channel is “not visible” to the tune initiator system if the tune initiator system cannot see data transferred over the channel.

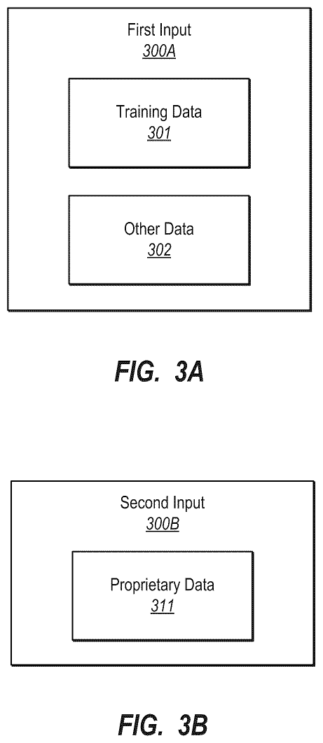

FIG. 3A illustrates an example of the first input 300A that is received from the tune initiator system. The first input 300A includes training data 301 amongst potentially other data 302. FIG. 3B illustrates an example of the second input 300B that is received from the provider system. The second input 300B includes proprietary data 311.

In one example, the proprietary data 311 received from the provider system is a base model. The base model provider may indeed consider numerous aspects of the base model to be proprietary including architecture, biases, weights, and so forth. A base model can be the result of considerable work, time, and investment. Accordingly, a base model provider may hesitate to allow its base model to be used to generate a fine-tuned model if the tune initiator system has direct access to that base model. The principles described herein may allow for the more open use of a base model for fine-tuning purposes while protecting the proprietary data of the provider system 120.

In another example, the proprietary data received from the provider system is fine-tuning computer executable instructions (e.g., a fine-tuning program). The provider system may also provide such a fine-tuning program, which may also be considered proprietary. Alternatively, the protected system 101 has its own fine-tuning program used to perform fine-tuning. Also, alternatively, the tune initiator system 110 may have provided the base model, and wish just to use the fine-tuning model or other proprietary information provided by the provider system 120.

Thus, the proprietary information 311 of the second input 300B received from the provider system could include, as example, a base model and/or a fine-tuning program. In addition, the other data 302, if any, provided by the tune initiator system could include the base model and/or a fine-tuning program.

Referring back to FIG. 2, after accessing the first and second inputs, the protected system uses the first input and the second input to fine-tune a machine learning model to thereby form a fine-tuned machine learning model (act 303). This could include applying a fine-tuning program (whether provided by the tune initiator system 110, the provider system 120, or the protected system 101 itself) to the base model and the training data. For instance, the fine-tuning program could be fine-tuning computer-executable instructions that are executable by one or more processors of the protected system to cause the protected system to perform the fine-tuning.

The protected system then stores the resulting fine-tuned model in the protected system (act 304). Due to the protection represented by box 130 in FIG. 1, this storage internal to the protected system means that while the tune initiator system can provide input to the fine-tuned machine learned model (e.g., over the channel 111) and can receive output from the fine-tuned machine learned model (e.g., also over the channel 111), the tune initiator system does not have visibility into the fine-tuned model itself. Thus, the tune initiator system cannot make inferences, based on what the fine-tuned model looks like, about what the original base model was.

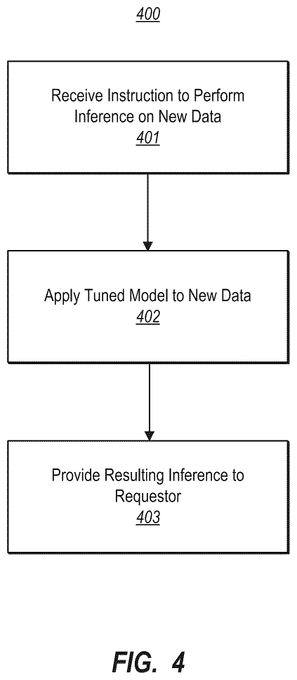

Accordingly, the fine-tuned model is kept within the protection of the protected system 101. FIG. 4 illustrates a flowchart of a method 400 for the tuner initiator system (or any other authorized system) to use the fine-tuned model to access an inference generated by that fine-tuned model. The protected system receives an instruction from the tune initiator system (or other authorized system) to perform an inference by applying the fine-tuned machine learning model to new data (act 401). In response to receiving this instruction, the protected system applies the fine-tuned model to the new data (act 402). The inference generated by the fine-tuned model is then provided to the tune initiator system (or other authorized system) (act 403).

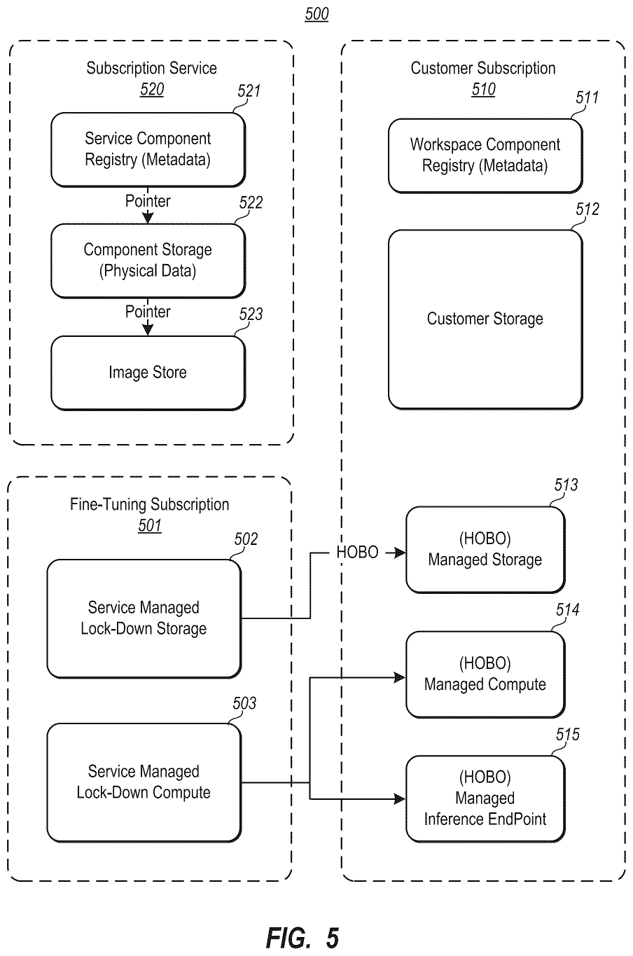

FIG. 5 illustrates an environment 500 that represents an example of the environment 100 of FIG. 1. The environment 500 includes a customer subscription 510, a service subscription 520, and a fine-tuning subscription 501 representing respective examples of the tune initiator system 110, the provider system 120, and the protected system 101 of FIG. 1.

The service subscription 520 includes a service components registry 521, centralized storage 522, and image store 523. The service components registry 521 is a catalog of components metadata in which published components are registered. Each workspace also has its own registry used by the service components registry 521. The centralized storage 522 stores published components. The component folder with data files will be kept within a service-level storage account. The reference images will be kept in the image store 523.

The fine-tuning subscription 501 includes a service-managed lock-down storage 502 that keeps proprietary data that should not be visible to the customer subscription 510. The customer subscription 510 does not have direct access to the service-managed lock-down storage 502. The storage could, for example, be a storage node in a cloud computing environment. The service-managed lock-down storage 502 is accessed in normal operation only by the service-managed lock-down compute 503. The compute 503 may be a compute node in a cloud computing environment. The service-managed lock-down compute actually performs the fine-tuning operation to generate the fine-tuned model.

Data structures may be imported from the service component registry 521 to the workspace component registry 511. As an example, the base model fine-tuning may be published as a service component (like a reusable job) that contains 1) components like scripts and configuration files (stored in component storage 522), 2) model artifacts for the base model (also stored in component storage 522), and 3) linked environment artifacts for the container image (stored in image store 523). All of these artifacts are protected. During import, the component metadata is copied from the service component registry 521 to the workspace component registry 511. In addition, the component folder is copied from the centralized storage 522 to the managed lock-down storage 502.

In order to run a fine-tuning job. A component (that includes the based model and scripts and binaries for the fine-tuning program) is loaded from component storage 522 into the service managed lock-down compute 503 (either directly or first via the service-managed lock-down storage 502). The customer subscription 510 provides training data into the customer storage, which is then also provided to the managed lock-down compute 503. The customer submits the fine-tuning job using the managed compute handler 514 and also the component metadata 511. The managed inference handler 515 may be a REST API which takes the input data in the request and returns the inference result in the response. The managed storage handler 513 is used as a reference to the fine-tuned model.

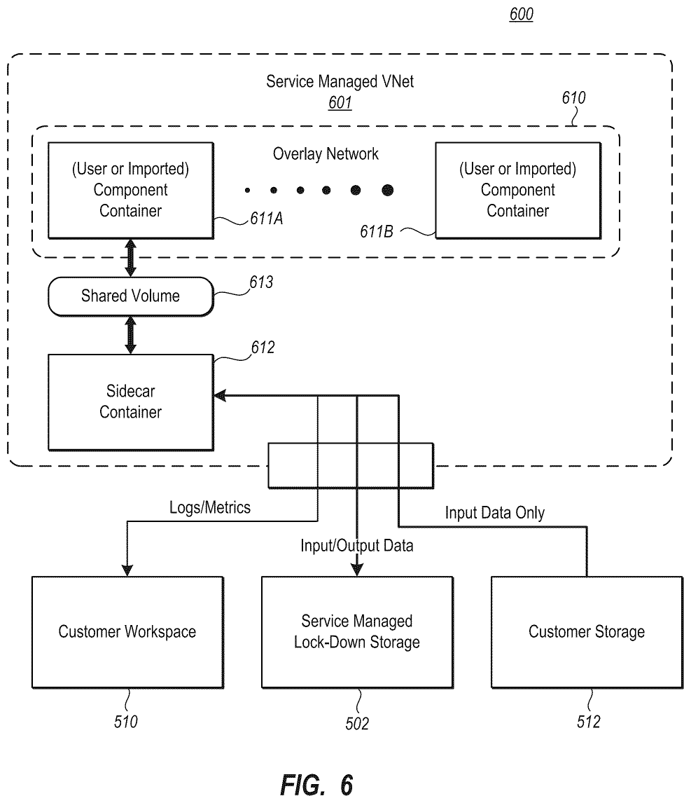

FIG. 6 illustrates an example lock-down compute 600, which represents an example of the lock-down compute 503 of FIG. 5. The lock-down compute 600 operates to protect data structures that should not be seen by the customer. When executing a customer component, no protected data structures will be leaked outside of the lock-down compute 600. Furthermore, when executing an imported component, no user data will be leaked to the internet.

The lock-down compute has a service-managed virtual network 601, which blocks any inbound or outbound connections, except lock-down storage 502, customer storage 512, and services managed within the service subscription 520. The component containers (e.g., 611A and 611B) rung within an overlay network 610. The components 611A and 611B can communicate with each other, but cannot make any inbound or outbound connections. Each component container has a service-managed sidecar container 612, with which they share a volume (e.g., volume 613) for input/output datasets. The sidecar container 612 will use proper credentials to connect to the lock-down storage 502 and customer storage 512. Input datasets could come from both lock-down storage 502 or customer storage 512. Output datasets (including the model) can only be put to lock-down storage 502. Logs and metrics from the imported component will be sent to the customer workspace 510. Logs/metrics from the customer component will be blocked.

Accordingly, the principles described herein provide an effective way for a tune initiator system to fine-tune a base model, while providing proper protection to parties that assist by providing proprietary data (such as base models and fine-tuning programs). Thus, the principles described herein embolden collaboration in the formation of new models, and allow for the rapid propagation of new models designed for new tasks.

Because the principles described herein are performed in the context of a computing system, some introductory discussion of a computing system will be described with respect to FIG. 7. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 includes at least one hardware processing unit 702 and memory 704. The processing unit 702 includes a general-purpose processor. Although not required, the processing unit 702 may also include a field programmable gate array (FPGA), an application specific integrated circuit (ASIC), or any other specialized circuit. In one embodiment, the memory 704 includes a physical system memory. That physical system memory may be volatile, non-volatile, or some combination of the two. In a second embodiment, the memory is non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods (and so forth) that may be executed on the computing system. Such an executable component exists in the heap of a computing system, in computer-readable storage media, or a combination.

One of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

1. A computing system comprising:
one or more processors; and
one or more computer-readable media having thereon computer-executable instructions that are structured such that, if executed by the one or more processors, the computing system would be configured to fine-tune a machine learning model in a protected environment such that a tune initiator system that instruct that the fine-tuning occur does not having visibility of a resulting fine-tuned model or at least some information used in the fine-tuning, by being configured to perform the following:
receive first input into the protected environment from the tune initiator system via a first channel that is visible to the tune initiator system, the first input including training data;
access second input over a second channel that is not visible to the tune initiator system;
use the first input and the second input to fine-tune a machine learning model to thereby form a fine-tuned machine learning model; and
store the fine-tuned machine learning model in the protected environment such that the fine-tuned machine learning model is available for the tune initiator system to provide input data to and receive output data from, but such that the fine-tuned machine learning model cannot be directly accessed by the tune initiator system.

2. The computing system in accordance with claim 1, the second input including a base model that is to be fine-tuned in the fine-tune to generate the fine-tuned model.

3. The computing system in accordance with claim 2, the second input including a fine-tuning computer-executable instructions, the computing system further being configured to perform the following:
execute the fine-tuning computer-executable instructions by one or more processors of a computing system to cause the computing system to use the base model accessed over the second channel and the training data received over the first channel to form the fine-tuned machine learning model.

4. The computing system in accordance with claim 2, the first input including fine-tuning computer-executable instructions, the computing system further configured to perform the following:
execute the fine-tuning computer-executable instructions by one or more processors of a computing system to cause the computing system to use the base model accessed over the second channel and the training data received over the first channel to form the fine-tuned machine learning model.

5. The computing system in accordance with claim 1, the first input including a base model that is to be fine-tuned in the fine-tune to generate the fine-tuned model.

6. The computing system in accordance with claim 1, wherein using the first input and the second input to fine-tune a machine learning model is performed using a plurality of containers, a first subset of the containers containing code provided by the tune initiator system, a second subset of the containers containing code not provided by the external network entity and which prevents the first subset of containers from accessing the Internet.

7. A computer-implemented method for fine-tuning a machine learning model in a protected environment such that a tune initiator system that instruct that the fine-tuning occur does not having visibility of a resulting fine-tuned model or at least some information used in the fine-tuning, the method comprising:
receiving first input into the protected environment from the tune initiator system via a first channel that is visible to the tune initiator system, the first input including training data;
accessing second input over a second channel that is not visible to the tune initiator system;
using the first input and the second input to fine-tune a machine learning model to thereby form a fine-tuned machine learning model; and
storing the fine-tuned machine learning model in the protected environment such that the fine-tuned machine learning model is available for the tune initiator system to provide input data to and receive output data from, but such that the fine-tuned machine learning model cannot be directly accessed by the tune initiator system.

8. The method in accordance with claim 7, the second input received over the second channel including a base model that is to be fine-tuned in the fine-tune to generate the fine-tuned model.

9. The method in accordance with claim 8, the second input received over the second channel including a fine-tuning computer-executable instructions, the method further comprising:
executing the fine-tuning computer-executable instructions by one or more processors of a computing system to cause the computing system to use the base model accessed over the second channel and the training data received over the first channel to form the fine-tuned machine learning model.

10. The method in accordance with claim 8, the first input received over the first channel including fine-tuning computer-executable instructions, the method further comprising:
executing the fine-tuning computer-executable instructions by one or more processors of a computing system to cause the computing system to use the base model accessed over the second channel and the training data received over the first channel to form the fine-tuned machine learning model.

11. The method in accordance with claim 7, the first input received over the first channel including a base model that is to be fine-tuned in the fine-tune to generate the fine-tuned model.

12. The method in accordance with claim 11, the second input received over the second channel including a fine-tuning computer-executable instructions, the method further comprising:
executing the fine-tuning computer-executable instructions by one or more processors of a computing system to cause the computing system to use the base model accessed over the first channel and the training data received over the first channel.

13. The method in accordance with claim 7, wherein using the first input and the second input to fine-tune a machine learning model is performed using a plurality of containers, a first subset of the containers containing code provided by the external network entity, a second subset of the containers containing code not provided by the external network entity and which prevents the first subset of containers from accessing the Internet.

14. The method in accordance with claim 13, the first subset of containers operating within an overlay network operating within a virtual network.

15. The method in accordance with claim 14, the code in the second subset of containers communicating outside of the virtual network using private endpoints.

16. The computing system in accordance with claim 1, wherein using the first input and the second input to fine-tune a machine learning model is performed using a plurality of containers, a first subset of the containers containing code provided by the external network entity, a second subset of the containers containing code not provided by the external network entity and which prevents the first subset of containers from accessing the Internet.

17. The computing system in accordance with claim 16, the first subset of containers operating within a virtual network.

18. The method in accordance with claim 17, the code in the second subset of containers communicating outside of the virtual network using private endpoints.
